(19) United States
(12) Patent Application Publication
(10) Pub. No.: US 2025/0102044 A1
(43) Pub. Date: Mar. 27, 2025

(54) INSULATING DEVICE FOR A BRAKE ACTUATING LINKAGE

(71) Applicant: DEERE & COMPANY, MOLINE, IL (US)

(72) Inventors: FELIX P. GREIF, EBERBACH (DE); ULRICH KNOBLOCH, ENKENBACH-ALSENBORN (DE); BERND KNEER, VIERNHEIM (DE); NILS WILKEN, MANNHEIM (DE); SHRIDIP BHATTACHARYA, BARRACKPORE (IN); JENS LETSCHER, ALBESSEN (DE); JONATHAN DENGLER, MANNHEIM (DE); HOLGER EDINGER, WEINHEIM (DE)

(21) Appl. No.: 18/887,702

(22) Filed: Sep. 17, 2024

(30) Foreign Application Priority Data
Sep. 25, 2023 (DE) 102023125 851.6

(51) Int. Cl. F16F 15/08; B60T 11/04; F16D 125/64

(52) U.S. Cl. CPC F16F 15/08; B60T 11/04; F16D 2125/64

(57) ABSTRACT

Insulating device for a brake actuating linkage, with a cylindrical insulating or damping bushing which comprises an inner cylinder sleeve, an outer cylinder sleeve coaxially surrounding the inner cylinder sleeve so as to form an annular gap, and an elastic element which fills the annular gap and is fixedly connected to the two cylinder sleeves, with a brake-pedal-side linkage section and a brake-valve-side linkage section, the two linkage sections engaging the insulating bushing along their cylinder axis on opposite sides such that the elastic element is sheared reversibly under the action of an increasing actuating pressure applied to the linkage sections by parallel displacement of the two cylinder sleeves in relation to each other until a mechanical end stop limiting the parallel displacement is reached.

### CROSS-REFERENCE TO RELATED APPLICATIONS

This application claims priority to German Patent Application No. 102023125851.6, filed Sep. 25, 2023, which is hereby incorporated by reference.

### TECHNICAL FIELD

The disclosure relates to an insulating device for a brake actuating linkage.

### BACKGROUND

Such a brake actuating linkage is used, for example, in agricultural tractors, to transmit the actuating force applied on the driver's side via a foot pedal to a control element of a brake valve for the hydraulic activation of associated wheel brake devices. Operationally induced vibrations caused by a hydraulic system connected to the brake valve can be transmitted back to the foot pedal in a manner which is perceptible to the driver and/or which is unpleasant via the brake actuating linkage. In this case, the rubber dampers conventionally used for insulating vibrations may influence the actuating force applied on the driver's side via the foot pedal and consequently may lead to an actuating behavior of the foot pedal that is undefined or is affected by losses in the braking effect which can be achieved.

### SUMMARY

In view of this, it is the object of the present disclosure to specify an improved insulating device of the type mentioned at the beginning in respect of the actuating behavior of the foot pedal, which insulating device at the same time ensures that an undesired transmission of vibrations back from the brake valve to the foot pedal is reduced.

This object is achieved by an insulating device for a brake actuating linkage having the features of one or more embodiments disclosed herein.

Accordingly, the insulating device for a brake actuating linkage, in addition to a cylindrical insulating or damping bushing which comprises an inner cylinder sleeve, an outer cylinder sleeve coaxially surrounding the inner cylinder sleeve so as to form an annular gap, and an elastic element which fills the annular gap and is fixedly connected to the two cylinder sleeves, furthermore has a brake-pedal-side linkage section and a brake-valve-side linkage section, the two linkage sections engaging the insulating bushing along their cylinder axis on opposite sides in such a way that the elastic element is sheared reversibly under the action of an increasing actuating pressure applied to the linkage sections by parallel displacement of the two cylinder sleeves in relation to each other until a mechanical end stop limiting the parallel displacement is reached.

In the installed state, the insulating device is coupled by the brake-pedal-side linkage section to a foot pedal provided for actuating the brakes or by the brake-valve-side linkage section to an actuation element of a brake valve for hydraulically activating associated wheel brake devices.

The shear strength of the elastic element is selected such that, when an actuating pressure typical for achieving an increased braking retardation occurs, a further parallel displacement is blocked because of the mechanical end stop and thus the function of the elastic element is bridged. This leads to a foot pedal actuating behavior which is defined and thus low-loss in terms of the achievable braking action, as is desirable, inter alia, when performing an emergency braking operation. The actuating pressure to be applied for this purpose lies typically in the order of magnitude of 500 newtons.

However, in the case of braking operations typical of normal driving, the actuating pressure lies below such a critical value, and therefore the mechanical end stop is not reached and the damping properties of the elastic element to this extent remain unaffected.

Advantageous developments of the insulating device according to the disclosure emerge from one or more embodiments disclosed herein.

In order to ensure that the actuating force acting via the brake actuating linkage is introduced, directed along the cylinder axis, into the insulation bushing, the brake-valve-side linkage section comprises a plunger which is received in a form-fitting manner by the inner cylinder sleeve, wherein the inner cylinder sleeve has a protrusion which projects beyond the elastic element and on which an actuating element surrounding the plunger is supported under the action of the actuating pressure applied to the linkage sections.

The plunger is for example, an integral component of the brake-valve-side linkage section, with a ball pin which is provided for the articulated fitting in a ball receptacle or socket and which is connected to the actuation element of the brake valve is formed at an end remote from the plunger.

The actuating element may be a threaded nut screwed onto an external thread of the plunger. The diameter of the external thread corresponds here to the inner diameter of the inner cylinder sleeve, and therefore the desired form fit between the two parts is produced. Alternatively, the actuating element is an integral component of the plunger and formed thereon as a surrounding collar. In this case, the plunger is designed without a thread and runs flat along an inner wall of the inner cylinder sleeve.

Furthermore, it is conceivable that the plunger is mounted longitudinally displaceably along the cylinder axis within the inner cylinder sleeve, which makes it possible, in the installed state of the brake actuating linkage, by rotating the threaded nut to a certain extent, to preload the insulating bushing or the elastic element surrounded by the latter for the purpose of adjusting the damping behavior. For this purpose, the external thread may be a fine thread, thus enabling precise adjustment.

Furthermore, the brake-pedal-side linkage section can comprise a bell-shaped housing for the form-fitting receiving of the insulating bushing, wherein a radially surrounding shoulder is formed within the bell-shaped housing, said shoulder keeping an inner end face of the inner cylinder sleeve at a distance from an inner housing head end when the elastic element is relaxed. This results in a particularly compact design of the insulating device, wherein the insulating bushing within the bell-shaped housing is additionally protected from external influences. The distance from the inner housing head end ensures the necessary movement clearance here for the inner cylinder sleeve to deflect inwards under the action of the actuating pressure.

There is also the possibility that the mechanical end stop is formed by the inner housing head end, by the inner end face of the inner cylinder sleeve coming to rest flat against said housing head end. In this case, the actuating pressure is transmitted between the two linkage sections with the elastic element being bridged by means of the rigid inner cylinder sleeve lying in between.

In order not to obstruct an inwardly directed deflection of the inner cylinder sleeve relative to the outer cylinder sleeve in the region of the elastic element, the width of the radially surrounding shoulder is dimensioned such that it does not exceed the wall thickness of the outer cylinder sleeve supported thereon, and consequently said shoulder is prevented from projecting into the annular gap and therefore into the movement region of the elastic element.

In particular in the case of a plunger received in a form-fitting manner by the inner cylinder sleeve, if a plunger end projects beyond the inner end face of the inner cylinder sleeve, it can be provided that at the inner housing head end there is a blind hole which is aligned with the profile of the inner cylinder sleeve and has an inner diameter which corresponds thereto or is larger. This allows the plunger end to enter the clearance created by the blind hole without the possibility of colliding with the adjacent housing head end.

Furthermore, it is possible that a fastening stub running along the cylinder axis is formed on the bell-shaped housing, in which fastening stub a free end or first end of a connecting rod of the brake-pedal-side linkage section is received, wherein furthermore a second end facing away from the free end or first end has a fastening eye for the articulated fitting to the foot pedal at a corresponding fastening point. A further external thread is formed along the free end or first end of the connecting rod and is screwed into an internal thread running along the cylinder axis in the fastening stub. By rotating the fastening stub and counter-locks using an additional threaded nut, a targeted length adjustment of the brake actuating linkage is possible.

Other features and aspects will become apparent by consideration of the detailed description, claims, and accompanying drawings.

### BRIEF DESCRIPTION OF THE DRAWINGS

The detailed description of the drawings refers to the accompanying figures.

The insulating device according to the disclosure for a brake actuating linkage is explained in more detail below using the attached drawings. Components of equivalent or comparable function are identified by the same reference signs. In the drawings:

FIG. 1 shows an exemplary embodiment of the insulating device according to the disclosure as a component of a brake actuating linkage,

FIG. 2 shows the brake actuating linkage, reproduced in FIG. 1, in an installed state in the footwell of a driver's cab of an agricultural tractor,

FIG. 3 shows a detailed view, reproduced in a sectional illustration, of the insulating device in an unactuated state, and

FIG. 4 shows the insulating device, reproduced in FIG. 3, in a fully actuated state.

Like reference numerals are used to indicate like elements throughout the several figures.

### DETAILED DESCRIPTION

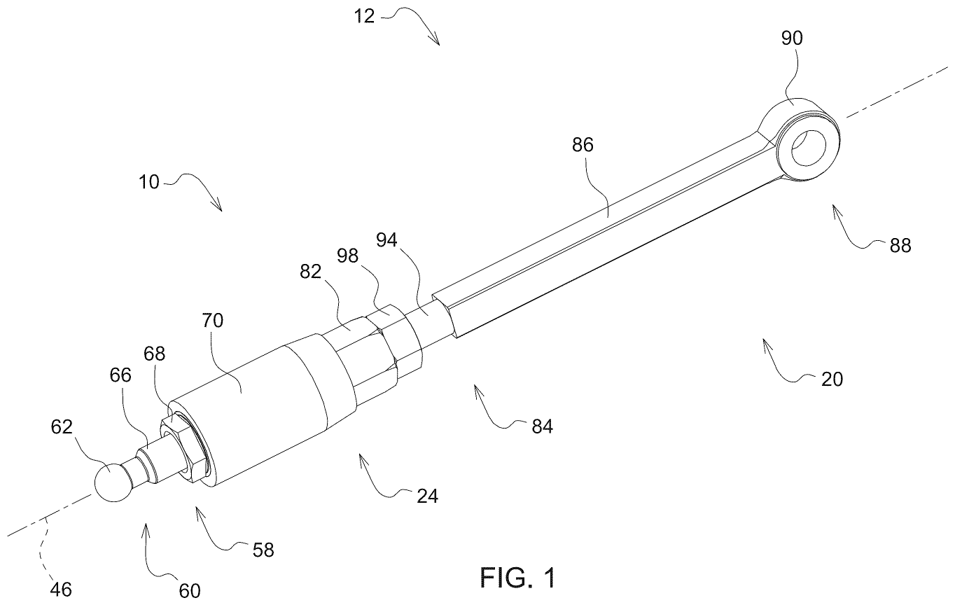

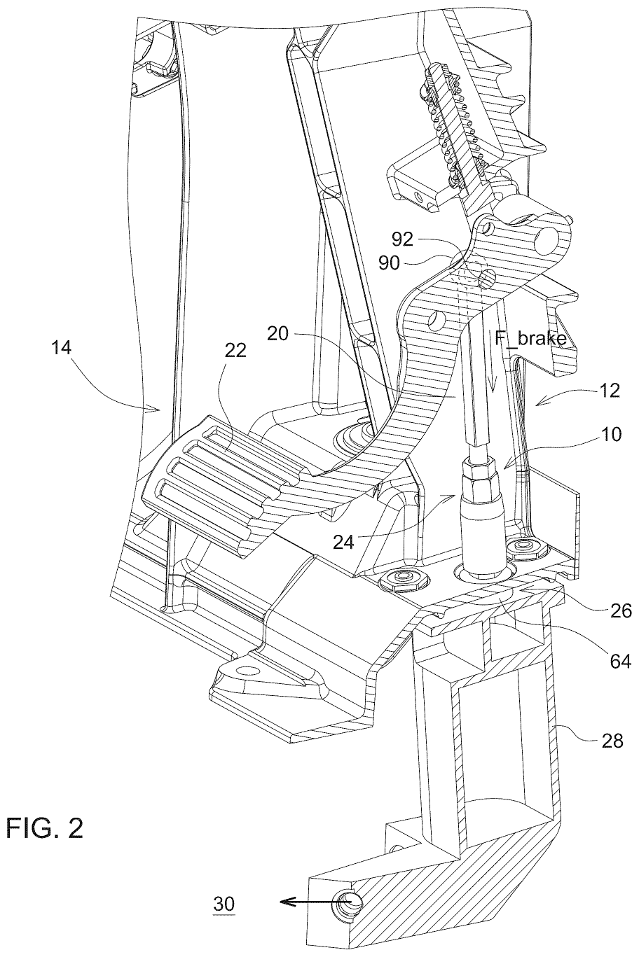

FIG. 1 shows an exemplary embodiment of the insulating device 10 according to the disclosure as a component of a brake actuating linkage 12, wherein the insulating device 10 according to FIG. 2 in an installed state is located in the footwell 14 of a driver's cabin 16 of an agricultural tractor 18, not reproduced specifically, and is coupled by a brake-pedal-side linkage section 20 to a foot pedal 22 provided for actuating the brakes or by a brake-valve-side linkage section 24 to an actuation element 26 of a brake valve 28 for the hydraulic activation of associated wheel brake devices 30 of the agricultural tractor 18.

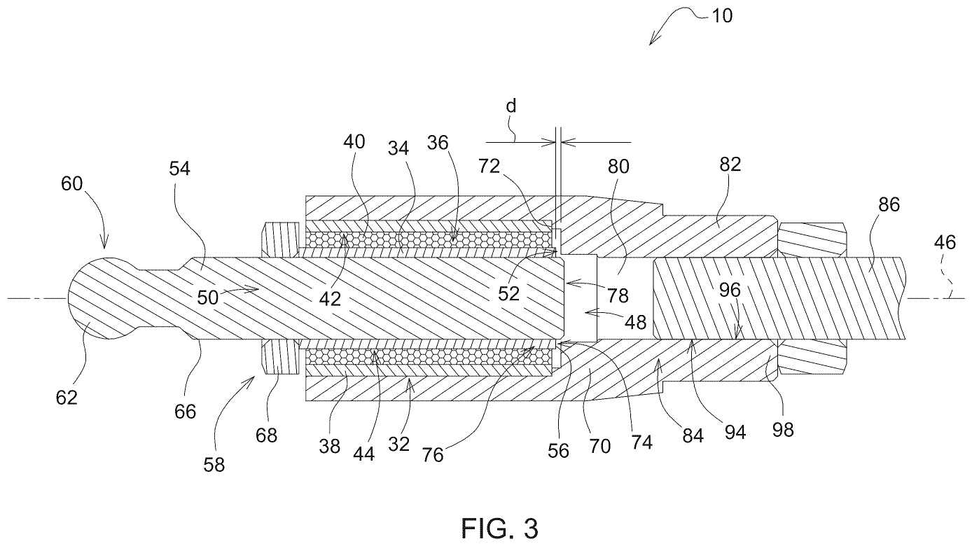

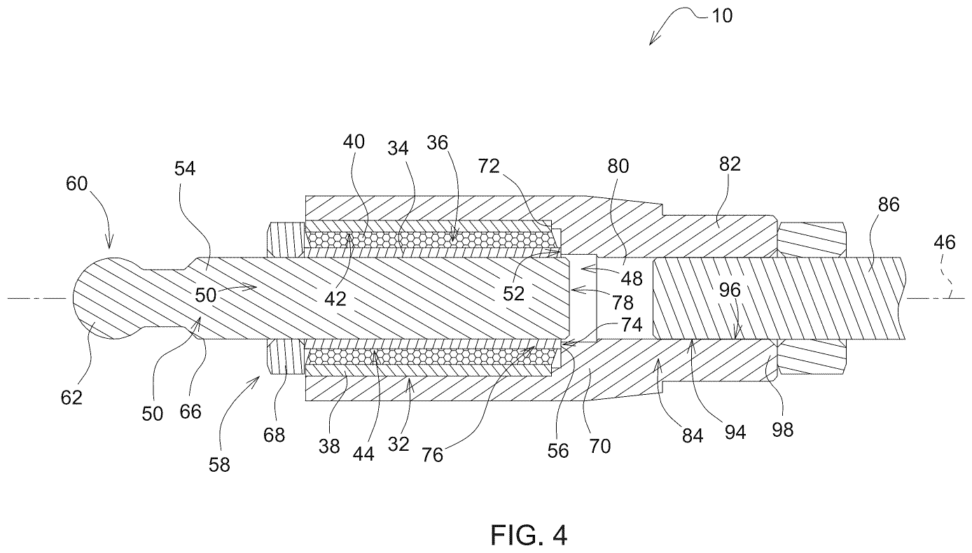

FIGS. 3 and 4 furthermore illustrate a detailed view of the insulating device 10 in section. Accordingly, the insulating device 10 has a cylindrical insulating or damping bushing 32 which comprises an inner cylinder sleeve 34, an outer cylinder sleeve 38 coaxially surrounding the inner cylinder sleeve 34 so as to form an annular gap 36, and an elastic element 40 which fills the annular gap 36 and is fixedly connected to the two cylinder sleeves 34, 38. The elastic element 40, which is composed of a vibration-damping rubber compound, is nonreleasably connected by vulcanizing to the inner or outer cylindrical wall 42, 44 of the inner or outer cylinder sleeve 34, 38, which is composed of galvanized or passivated steel.

In this case, the two linkage sections 20, 24 engage the insulating bushing 32 along their cylinder axis 46 on opposite sides 48, 50 in such a way that the elastic element 40 is sheared starting from an unactuated state, reproduced in FIG. 3, under the action of an increasing actuating pressure F_brake applied to the linkage sections 20, 24, with parallel displacement of the two cylinder sleeves 34, 38 in relation to each other until a mechanical end stop 52 limiting the parallel displacement is reached. The latter corresponds to a fully actuated state, reproduced in FIG. 4, of the elastic element 40. The shearing is reversible because of the elastic properties of the insulating bushing 32, i.e., the elastic element 40 automatically returns into the unactuated state as the actuating pressure F_brake decreases.

The shear strength of the elastic element 40 is selected such that, when an actuating pressure F_brake typical for achieving an increased braking retardation occurs, a further parallel displacement is blocked because of the mechanical end stop 52 and thus the function of the elastic element 40 is bridged. This leads to an actuating behavior of the foot pedal 22 which is defined and thus low-loss in terms of the achievable braking action, as is desirable, inter alia, when performing an emergency braking operation. The F_brake actuating pressure to be applied for this purpose lies typically in the order of magnitude of 500 newtons.

However, in the case of braking operations of the agricultural tractor 18 typical of normal driving, the actuating pressure F_brake lies below such a critical value, and therefore the mechanical end stop 52 is not reached and the damping properties of the elastic element 40 to this extent remain unaffected.

In order to ensure that the actuating force F_brake acting via the brake actuating linkage 12 is introduced, directed along the cylinder axis 46, into the insulating bushing 32, the brake-valve-side linkage section 24 comprises a plunger 54 which is received in a form-fitting manner by the inner cylinder sleeve 34. The inner cylinder sleeve 34 has a protrusion 56 which projects beyond the elastic element 40 and on which an actuating element 58 surrounding the plunger 54 is supported under the action of the actuating pressure F_brake applied to the linkage sections 20, 24. The plunger 54 is an integral component of the brake-valve-side linkage section 24, with a ball pin 62 which is provided for the articulated fitting in a ball receptacle or socket 64, visible in FIG. 2, and which is connected to the actuation element 26 of the brake valve 28 is formed at an end 60 remote from the plunger 54.

As an example, the actuating element 58 is a threaded nut 68 screwed onto an external thread 66 of the plunger 54. The diameter of the external thread 66 corresponds here to the inner diameter of the inner cylinder sleeve 34, and therefore the desired form fit between the two parts is produced.

The plunger 54 is mounted longitudinally displaceably along the cylinder axis 46 within the inner cylinder sleeve 34, which makes it possible, in the installed state of the brake actuating linkage 12, by rotating the threaded nut 68 to a certain extent, to preload the insulating bushing 32 or the elastic element 40 surrounded by the latter for the purpose of adjusting the damping behavior. For this purpose, the external thread 66 is a fine thread, thus enabling precise adjustment.

In addition, the brake-pedal-side linkage section 20 comprises a bell-shaped housing 70 for the form-fitting receiving of the insulating bushing 32. A radially surrounding shoulder 72 is formed within the bell-shaped housing 70, said shoulder keeping an inner end face 74 of the inner cylinder sleeve 34 at a distance d from an inner housing head end 76 when the elastic element 40 is relaxed. The distance d from the inner housing head end 76 ensures the necessary movement clearance here for the inner cylinder sleeve 34 to deflect inwards under the action of the actuating pressure F_brake.

In the present case, the mechanical end stop 52 is formed by the inner housing head end 76, by the inner end face 74 of the inner cylinder sleeve 34 coming to rest flat against said housing head end. In this case, the actuating pressure F_brake is transmitted between the two linkage sections 20, 24 with the elastic element 40 being bridged by means of the rigid inner cylinder sleeve 34 lying in between.

In order not to obstruct an inwardly directed deflection of the inner cylinder sleeve 34 relative to the outer cylinder sleeve 38 in the region of the elastic element 40, the width of the radially surrounding shoulder 72 is dimensioned such that it does not exceed the wall thickness of the outer cylinder sleeve 38 supported thereon, and consequently said shoulder is prevented from projecting into the annular gap 36 and therefore into the movement region of the elastic element 40.

For the case shown in FIGS. 3 and 4 that a plunger end 78 protrudes over the inner end face 74 of the inner cylinder sleeve 34, at the inner housing head end 76 there is a blind hole 80 which is aligned with the profile of the inner cylinder sleeve 34 and has an inner diameter which corresponds thereto or is larger. This allows the plunger end 78 to enter the clearance created by the blind hole 80 without the possibility of colliding with the adjacent housing head end 76.

In addition, a fastening stub 82 running along the cylinder axis 46 is formed on the bell-shaped housing 70. A free end or first end 84 of a connecting rod 86 of the brake-pedal-side linkage section 20 is received in the fastening stub 82, a second end 88 facing away from the first end 84 furthermore has a fastening eye 90 for the articulated fitting to the foot pedal 22 at a corresponding fastening point 92 (also see FIG. 2).

A further external thread 94 is formed along the first end 84 of the connecting rod 86 and is screwed into an internal thread 96 running along the cylinder axis 46 in the fastening stub 82. By rotating the fastening stub 82 and counter-locks using an additional threaded nut 98, a targeted length adjustment of the brake actuating linkage 12 is possible.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An insulating device for a brake actuating linkage, with a cylindrical insulating or damping bushing which comprises an inner cylinder sleeve, an outer cylinder sleeve coaxially surrounding the inner cylinder sleeve so as to form an annular gap, and an elastic element which fills the annular gap and is fixedly connected to the inner cylinder sleeve and the outer cylinder sleeve, with a brake-pedal-side linkage section and a brake-valve-side linkage section, the brake-pedal-side linkage section and the brake-valve-side linkage section engaging the insulating bushing along their cylinder axis on opposite sides such that the elastic element is sheared reversibly under the action of an increasing actuating pressure applied to the brake-pedal-side linkage section and the brake-valve-side linkage section by parallel displacement of the inner cylinder sleeve and the outer cylinder sleeve in relation to each other until a mechanical end stop limiting the parallel displacement is reached.

2. The insulating device of claim 1, wherein the brake-valve-side linkage section comprises a plunger which is received in a form-fitting manner by the inner cylinder sleeve, and the inner cylinder sleeve has a protrusion which projects beyond the elastic element and on which an actuating element surrounding the plunger is supported under the action of the actuating pressure applied to the brake-pedal-side linkage section and the brake-valve-side linkage section.

3. The insulating device of claim 2, wherein the plunger is an integral component of the brake-valve-side linkage section.

4. The insulating device of claim 2, wherein the actuating element is a threaded nut screwed onto an external thread of the plunger.

5. The insulating device of claim 2, wherein the plunger is mounted longitudinally displaceably along the cylinder axis within the inner cylinder sleeve.

6. The insulating device of claim 1, wherein the brake-pedal-side linkage section comprises a bell-shaped housing for the form-fitting receiving of the insulating bushing, and a radially surrounding shoulder is formed within the bell-shaped housing, and the radially surrounding shoulder keeps an inner end face of the inner cylinder sleeve at a distance from an inner housing head end when the elastic element is relaxed.

7. The insulating device of claim 6, wherein the mechanical end stop is formed by the inner housing head end, by the inner end face of the inner cylinder sleeve coming to rest flat against the housing head end.

8. The insulating device of claim 6, wherein the width of the radially surrounding shoulder is dimensioned such that it does not exceed the wall thickness of the outer cylinder sleeve supported thereon.

9. The insulating device of claim 6, further comprising a blind hole at the inner housing head end, aligned with the profile of the inner cylinder sleeve and having an inner diameter which corresponds thereto or is larger.

10. The insulating device of claim 6, wherein a fastening stub running along the cylinder axis is formed on the bell-shaped housing, in which fastening stub a free end of a connecting rod of the brake-pedal-side linkage section is received, and wherein a further external thread is formed along the free end of the connecting rod and is screwed into an internal thread running along the cylinder axis in the fastening stub.
